(19) United States
(12) Patent Application Publication
(10) Pub. No.: US 2021/0291093 A1
(43) Pub. Date: Sep. 23, 2021

(54) Fluid Filter Apparatus and Method

(71) Applicant: Nathaniel B. Oler, Bend, OR (US)

(72) Inventor: Nathaniel B. Oler, Bend, OR (US)

(21) Appl. No.: 17/194,969

(22) Filed: Mar. 8, 2021

Related U.S. Application Data
(60) Provisional application No. 62/990,658, filed on Mar. 17, 2020.

(51) Int. Cl. B01D 39/10; B01D 29/13; B01D 35/30

(52) U.S. Cl. CPC B01D 39/10; B01D 2201/34; B01D 35/30; B01D 29/13

(57) ABSTRACT

A metal sintered filter insert for fluid filtering is provided in a configuration whereby a perimeter edge of the sintered filter element is in a fused connection to annular supports on both sides of the filter material. The annular supports in the fused engagement to the perimeter of the filter element prevent the edge from dismounting under fluid pressure.

This application claims priority to U.S. Provisional Patent Application Ser. No. 62/990,658, filed on Mar. 17, 2020, which is incorporated herein in its entirety by this reference thereto.

### BACKGROUND

### 1. Field of the Invention

The invention relates to fluid filtering such as filtering in a brewery, cannery, food production plant, or other industrial fluid filtering system. More particularly, the device and method herein relate to a sintered filter which is configured to allow high process, low temperature micron filtration of media, without risk of blow-by, filter failure, or temperature or pressure concerns.

### 2. Prior Art

Fluid filtration in a commercial setting frequently employs a sintered filter element rather than fabric or other filter elements. A sintered filter employs metal media to form a sintered powder filter cartridge which is positioned inline with a fluid flow to be filtered of particulate and other impurities.

Modern sintered filters provide excellent performance for separation of micro particulate matter from either liquid or gas process streams. They are, thus, widely employed in numerous industrial liquid and gas filtration applications as a means to purify the fluid stream passing through the filter.

Conventionally, in sintered filter media the filter is fabricated from either metal fibers or metal powders which are formed into filtration elements. Such metals include but are not limited to stainless steel, bronze, nickel based alloy, titanium and special alloyed powders or stainless steel fibre felt. These metallic filters are, thus, widely employed in the beverage industry as well as the chemical process, petrochemical and power generation industries, for the removal of unwanted particulate and to protect downstream equipment from such. They are also conventionally employed for product separation and to meet environmental regulations

Sintered powder filter cartridges, positioned within a pressurized fluid stream, conventionally provide high particle efficiency removal as well as reliable filtration performance. Such sintered filters conventionally are configured to provide particulate capture efficiencies of 99.9% or better. Further, because they are formed of metal, the operating temperature of modern sintered filters can be as high as 1000° C., depending on the selection of metal alloy forming the filter element.

The life span of a sintered filter conventionally depends on the particulate holding capacity of the formed filter and the corresponding pressure drop during use. The particulate captured within such sintered filters can frequently accumulate therein, but in many cases can be removed by a reverse fluid flow or blow-back cycle.

However, because of the micro filtering capability of such sintered filters, and the high pressure high fluid volume in which they operate, there is a constant risk of filter deformation under fluid pressure. When the filter deforms, in virtually all cases, it disengages around a portion of the perimeter of the filter. It can result in an unfiltered fluid flow through formed channels around the perimeter of the filter. Such can significantly affect quality of the product which employs the filter due to the unwanted particulate passed around the sintered filter.

The forgoing examples of sintered filters and limitations related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF INVENTION

The device and method herein provides a solution to the shortcomings of conventional sintered filters which are positioned inline with a fluid flow. It is especially well configured for use in a tri-clamp engagement within pressurized fluid flow communicating through a metal conduit.

In such a configuration, the sintered filter is formed in a disk configuration having an exterior circumference which is engaged with a mounting ring. The mounting ring is configured with two parallel shoulders extending from the exterior circumference on opposite ends of the ring. A fluid conduit runs through the interior of the ring, and the sintered filter is engaged with the interior sidewall defining the fluid conduit. Clamps are positioned to compress upon each of the two shoulders and sealably engage them to the pipe or conduit at both ends of the mounting ring.

So positioned, all fluid flowing through the pipe or conduit must pass through the fluid conduit running through the mounting ring. The sintered filter engaged within the fluid conduit in the mounting ring should, thus, filter all fluid flowing from the inlet pipe, through the fluid conduit in the mounting ring, to the outlet pipe.

However, conventional sintered filter elements are configured to capture particulate down to the micron level in size. For example, such sintered filters are available for positioning within the fluid conduit of mounting rings, which will filter particulate from as large as 40 microns to as small as 0.2 microns or smaller.

In sintered filter elements with very small passages, which are adapted to capture such particulate as small as 0.2 microns, the pressure of the fluid containing the sintered filter communicated from the inlet pipe can cause a deformation of the filter element from the hydraulic forces. These forces build as the filter element captures particulate in the filtration passages since less area is available for fluid passage through the filter as it continuously captures clogging particulate. The ever increasing hydraulic force on the sintered filter will eventually cause failure thereof. However, more frequently, a perfectly good sintered filter will deform under the hydraulic pressure and allow passage of unfiltered fluid around the perimeter edge of the sintered filter at its sealed contact with the interior circumference of the fluid passage to which the filter is sealably engaged.

This communication of unfiltered fluid flow around the sintered filter can easily go unnoticed because a very small dis-configuration of the filter element will allow such fluid passage under pressure, but may not be visible upon inspection when the sintered filter element is not pressurized. When high temperature fluids are being filtered the differing rates of thermal expansion between the metal sintered filter, the polymeric seals, and the metal forming the inlet and outlet pipes, exacerbates the potential for blow-by past the filter perimeter.

In search of a solution to the problem, numerous polymeric and metallic seals were experimented with to sealably engage the exterior circumference surface of the metallic sintered filter with the interior surface defining the fluid conduit of the mounting ring or passage for fluid.

In addition to forming circumferential seals of various shapes and shore hardness, configurations of the fluid conduit with annular projections on opposing sides of the disk shaped sintered filter were constructed to help seal the sintered filter and prevent deformations, which cause such blow-by, were also attempted. Combinations of differing polymeric seals shapes, along with both softer and harder shore, in combination with such annular projections, were also attempted in search of a solution.

With all such configurations and combinations of seals and deformation preventing structures, blow-by of fluid past the sintered filter element perimeter edge was still found due to deformation under fluid pressure. This occurred especially frequently under very high pressure fluid flows with the metal sintered filter configured to capture micronic particulate and the like. Higher temperature fluid flows continued to also cause more frequent perimeter deformation and increased blow-by.

As a consequence of continued blow-by issues with fluid flow in the numerous experimental seal and structure configurations and tests, a totally different filter perimeter engagement was experimented with due to the multiple failures. The configuration for the fluid conduit of the mounting ring was tried in a number of configurations which did not employ the failed prior configurations.

In a first configuration, in an abandonment of conventional configurations, allowing removal and replacement of the filter element into slots and the like, the circumferential perimeter of the sintered filter itself was fused to the interior circumferential surface, defining the fluid passage through the mounting ring by arc welding. While this non conventional configuration appeared to solve perimeter edge fluid blow-by problems, a second configuration was determined to be even more superior in that it allowed for prefabrication of entire filter elements, which could be removably mated with mounting rings.

In the preferred mode of the sintered filter element herein disclosed, a sintered metallic filter element having the desired micronic or other filtering passage size is first positioned between two annular metal support rings. The circumferential perimeter edge of the metallic filter and opposite side portions adjacent thereto of the filter element are then permanently fused in a fused connection to both of the rings by arc welding or laser welding the facing surfaces of both annular support rings to each other and the filter element. This results in a unitary filter structure which is formed of opposing metal annular support rings positioned on both sides and fused in the welding to the metallic filter element. It should be noted that where fused area or fused connection are used herein, it is meant that a welding device such as an arc welder or laser and/or welding rod have been employed to heat and melt all metal surfaces in a single fused connection. Should metal rods be required and form part of this fused connection, it would be of an appropriate metal used in welding which is well known to vary depending on the types of metals being fused. Here it is anticipated the filter may be bronze, brass, or aluminum or stainless steel and that the annular supports may be any of the same metals.

The circumferential surfaces of both support rings are also aligned in a butt type weld in the fused area positioned in-between them, which holds the two support rings aligned and engaged to the perimeter edge of the sintered filter. The exterior circumferential surface of the unitary filter element structure, formed of two metal annular support rings welded to the metallic filter element, has a first diameter size.

This circumferential surface of the filter element formed in a unitary structure is engaged with the surface of an axial passage communicating through a mounting ring which is adapted for engagement between an intake pipe and an outlet pipe carrying pressurized fluid. Currently, annular shoulders projecting from the exterior circumference of the mounting ring provided engagement for clamps to hold the mounting ring in a sealed engagement between an intake pipe or conduit and an outlet pipe or conduit. However, the mounting ring can be adapted to sealably engage in such a position using other connections such as threads.

Currently, the preferred means for engagement of the unitary filter structure formed of the metallic filter welded to the annular support rings is an engagement formed by a press fit. In this engagement, the first diameter of the surface of the exterior circumference of the filter in welded engagement to the opposing support rings is substantially equal, to a second diameter of the axial passage running through the mounting ring which defines the fluid conduit through the mounting ring.

In this configuration, the unitary filter element structure is then press fit into engagement with the axial passage using a hydraulic press or the like. So engaged, the unitary filter element structure will resist movement or dismount from the axial passage due to fluid pressure during use. Additionally, because the circumferential edge of the metal sintered filter is in a welded engagement with and between both of a first annular support ring and a second annular support ring, blow-by around a dismounted sintered filter is eliminated. The filter element structure can be changed if needed, by using a hydraulic press to press it out of engagement with the mounting ring and pressing in a new unitary filter element structure.

Alternatively, but less preferred, the sintered filter element can be welded at its perimeter edge to the interior surface of the axial passage defining the fluid conduit through the mounting ring. However, while in experimentation it was found that this mode will function to help eliminate blow-by fluid flow, it requires the replacement of the entire mounting ring and did not resist dismounting as well because it did not include the additional circumferential support of opposing support rings against both sides of the unitary filter element once welded. Experimentation showed that this configuration would place significant force on the weld around the circumference of the metallic sintered filter, which may not be desirable in a high fluid flow high temperature environment.

With respect to the above description, before explaining at least one preferred embodiment of the herein disclosed sintered filter for filtering fluids in detail, it is to be understood that the disclosed sintered filter herein is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed sintered filter. It is important, therefore, that the claims be regarded as including such equivalent construction and methodology insofar as they do not depart from the spirit and scope of the present invention.

The objects, features, and advantages of the present sintered filter invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE DRAWINGS

The accompanying drawings, which are incorporated herein and form a part of the specification, illustrate some, but not the only or exclusive, examples of embodiments and/or features of the sintered filter invention herein. It is intended that the embodiments and figures disclosed herein are to be considered in all cases illustrative, rather than limiting.

In the drawings:

FIG. 1 shows an assembled sintered filtering device in a perspective view showing the unitary sintered filter element engaged within an axial passage of a mounting ring.

FIG. 2 shows an exploded view of the filter element device, showing a welded filter element insert, configured to a unitary structure with annular supports on both sides, having an exterior circumferential surface diameter sized for a hydraulic press fit with and against the circumferential surface defining a fluid passage through a mounting ring.

FIG. 3 depicts the sintered filter element in an exploded view of the components of FIG. 4, showing the metallic sintered filter element sandwiched between a first annular support ring and a second annular support ring prior to welding to form a unitary filter element structure shown in FIG. 4.

FIG. 4 depicts the unitary filter element insert showing the fused area viable as a weld bead fusing the circumferential edge of the sintered filter element in a fused connection with both of the first and second annular support rings.

FIG. 5 shows a sectional view through FIG. 1, showing the unitary filter element insert formed of the first and second annular support rings which are welded to each other as well as the circumferential edge of the sintered filter element, where the filter element insert has been positioned using a press-fit engagement within the axial passage of a mounting ring.

Other aspects of the disclosed sintered fluid filter device herein will be more readily understood when considered in conjunction with the accompanying drawings, and the following detailed description, neither of which should be considered limiting.

### DETAILED DESCRIPTION OF EMBODIMENTS

In this description, any directional prepositions if employed, such as up, upwardly, down, downwardly, front, back, first, second, top, upper, bottom, lower, left, right and other such terms referring to the device or depictions as such may be oriented, are describing it such as it appears in the drawings and are used for convenience only. Such terms of direction and location are not intended to be limiting or to imply that the device herein has to be used or positioned in any particular orientation.

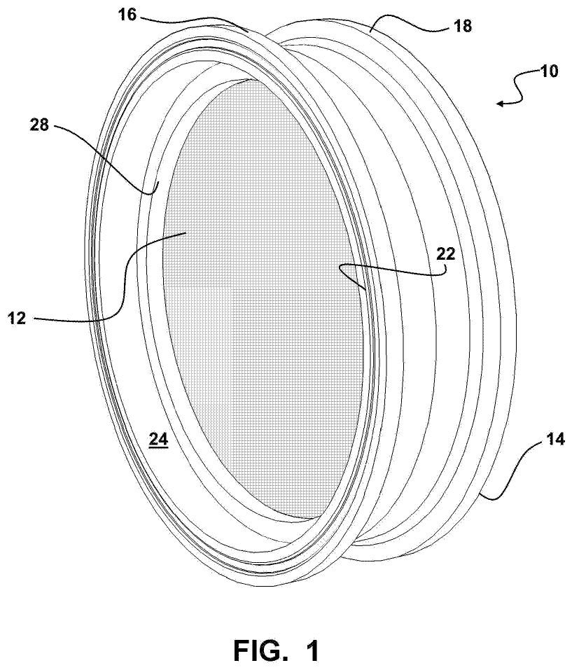

Now referring to the drawings of FIGS. 1-5, where similar components are identified with like numeral references, there is seen in FIG. 1 an assembled sintered filtering device 10 which is depicted in a perspective view showing the sintered filter element 12 in a fixed engagement within a mounting ring 14 to form a filter element insert 26. While this insert formed of fused metal components can be employed by itself and pressed or otherwise mounted within a conduit to filter fluid flow, and such is included in the scope of this application, it is preferred for ease of use to have it engaged with a mounting ring 14.

The mounting ring 14 is adapted for a sealed engagement between an inlet pipe and outlet pipe of a conventional system (not shown but well known) having pressurized fluid flow therebetween that is to be filtered by the device 10 herein.

The device 10 is adapted for sealed engagement between an inlet pipe and an outlet pipe, so as to carry fluid to be filtered through the metallic sintered filter element 12 positioned within the fluid passage 20 surrounded by the body of the mounting ring 14. Such an adaptation for sealed engagement, for example, can be a first mounting shoulder 16 which is positioned at a first end and a second mounting shoulder 18 which is positioned at a second end of the mounting ring 14. Clamps (not shown but well known) are used to compressibly engage the first mounting shoulder 16 against an end of the inlet pipe and the second mounting shoulder 18 against an end of an outlet pipe, and a seal 22 can also be included on each of the first end and second end of the mounting ring 14.

The metal sintered filter element 12 is formed of metal material in a fashion to capture particulate in the fluid stream to prevent communication thereof between the inlet pipe and outlet pipe. The sintered metal filter element 12 can be configured, for example, to block particulate in a range of size from, for example, 0.2-40 microns. Of course other particulate blocking sizes in such a filter may be employed and are considered within the scope of this invention.

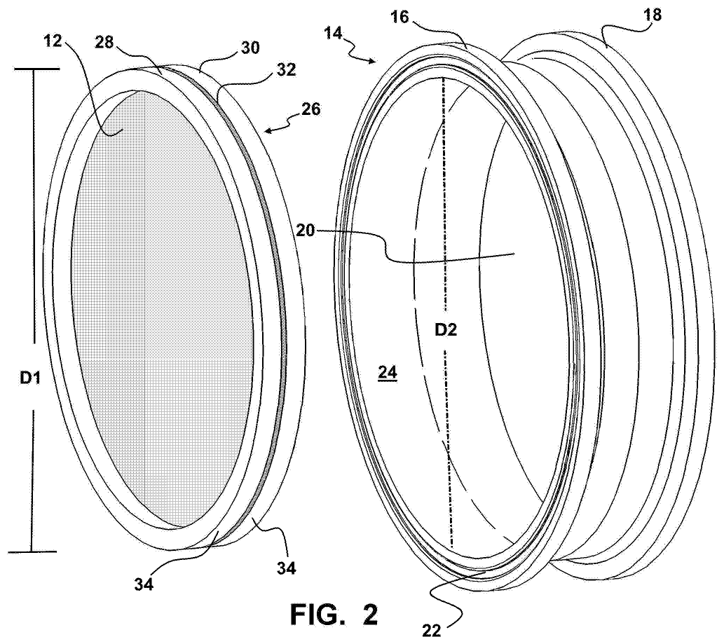

As noted above, the sintered filter element 12 being comprised of metal, can be welded to form a fused connection around a perimeter edge thereof directly to the interior surface 24 defining the fluid passage 20. However, in the preferred mode of the device 10, the filter element 12 is formed to a filter element insert 26 (FIGS. 2-4) which is then press fit into the fluid passage 20 communicating through the mounting ring 14. This is because the two annular supports 28 and 30, when fused to the perimeter of the seal 12, significantly increase resistance to deflection and thereby prevent failure.

As depicted in FIGS. 2-4, the filter element insert 26 is formed of a sintered filter element 12 and a first annular support 28 on one side of the filter element 12 and a second annular support 30 positioned on the opposite side of the filter element 12. This filter insert 26 is engaged in a press fit within the fluid passage 20 of the mounting ring 14.

A fused connection depicted as a welding bead 32 formed of fused metal material during the arc weld or laser weld or other welding process, permanently forms a fused connection of the metal of one side surface of the first annular support 28 to the metal forming the circumferential edge portion of the filter element 12. While forms of the device 10 may be formed without it, the fused connection is preferably also formed with the metal of the side surface of the second annular support 30 to the metal forming the circumferential edge portion of the filter element 12 to increase strength and resistance to perimeter deflection of the filter. The fused connection shown by the weld bead 32 also forms a fused connection between the first annular support 28 to the second annular support 30, thereby forming the filter element insert 26 to a unitary structure.

As shown in FIG. 2, the perimeter edge surface 34 of both the first annular support 28 and the second annular support 30 are aligned and have a first diameter shown as D1. The outside diameter of the fused connection area shown as a welding bead 32 is either equal to the first diameter D1, which can be accomplished by sanding or grinding or machining, or is slightly recessed in between the perimeter edge surfaces 34 of the first annular support 28 and second annular support 30.

Also shown in FIG. 2, the interior surface 24, defining the fluid passage 20 through the mounting ring 14, has a diameter D2. The diameter D1 is preferably sized to engage the filter element insert 26 in a press fit engagement within the fluid passage 20. By press fit is meant that a hydraulic press or other press with mechanical advantage is employed to press the filter element 26 into engagement with the fluid passage 20. Currently forming D1 equal to D2 or substantially equal is preferred. By substantially equal is meant that the diameter D1 is equal to or within 10 thousands of an inch of the diameter of D2. An excellent press fit engagement can be achieved by heating the mounting ring 14 to slightly expand it and inserting the cooler filter element insert 26 with the mounting ring 14 heated. While not preferred, this heating and different temperatures of components allows a user without a press to engage the filter element insert 26 in the press fit with the mounting ring. Where D1 is a few thousandths of an inch larger than D2, when the mounting ring 14 contracts, a biased engagement between the exterior of the element insert 26 and the interior surface 24 of the mounting ring 14 is formed which is removably engaged but will require a hydraulic press or similar mechanical advantage to remove.

Depicted in FIG. 5, is a sectional view through FIG. 1 showing the filter element insert 26 formed of the first annular support 28 and second annular support 30. The fused area defined in the area of the welding bead 32 forms a fused connection of the metal of the first annular support 28 to the second annular support 30. The fused area in the area of the welding bead 32 also connects a first facing side on the first annular support 30 to a circumferential edge portion completely surrounding the entire filter element 12. This fused area or welding bead 32 also permanently fuses the metal of a first facing side of the second annular support 30 to the meal of the circumferential edge portions 36 of the filter element 14. Thus, a fused connection in the fused area or welding bead 32 forms a metallic fused connection, of all of the components forming the filter element insert 26 to each other, forming a unitary structure from the multiple components.

No matter which way the fluid flows through the filter element, the fused first and second annular supports 28 and 30, provided a fused engagement to the perimeter of the filter element 12 around its entire perimeter. This prevents any portion of the circumference of the filter element 12 from dismounting during use and allowing unfiltered liquid to pass.

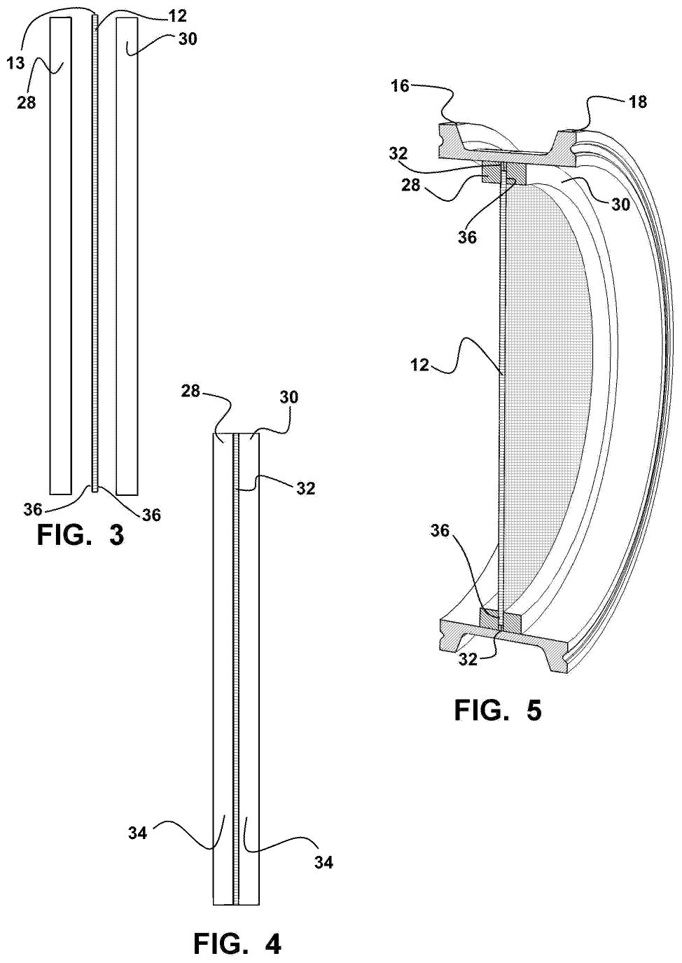

As shown in FIGS. 3-5, and as noted above, the filter element 12 is a sintered metal material. The mounting ring 14 and the first annular support 28 and the second annular support 30 are also formed of metal such as stainless steel or aluminum or a metal adapted to the intended filtering system. The fused connection in the area of the encircling welding bead 32 is formed using an arc welder engaged to appropriate welding material or other appropriate welding device such as a laser or other device for heating the area to be fused. Welding rod or the like formed of an appropriate metal material, to form the fused area, such as nickle or another appropriate metal welding material adapted to fuse the three metallic components together in a unitary structure, may also be employed in conventional fashion. Such may vary depending on the metal forming the annular supports 28 and 30 and the sintered filter 12.

In a method of manufacture of the device 10, a sintered metallic filter element 12 is positioned in between a first annular support 28 and second annular support 30 as shown in FIG. 3. All these components are placed and held in contact with each other with the filter element 12 in a biased engagement between the first annular support 28 and second annular support 30. In this engagement, the exterior circumferential surfaces of the annular supports are preferably aligned such that the fused structure will have them so aligned.

While in such biased engagement (for example with clamps holding the components together in a compressed state) a welding device such as an arc welder or laser, which may also be connected to welding material, such as a welding rod or wire welder or the like, is employed to fuse the annular supports 28 and 30 with both the perimeter edge of the filter element 12 and each other. Upon completion of the welding, a unitary structure is formed with a fused area shown as a welding bead 32 around the entire circumferential edge of the contacting components. This results in exterior circumferential surfaces of the annular supports 28 being aligned in a butt weld and with the circumferential edge of the filter element 12 fused therewith and therebetween.

Portions of surfaces of the filter element 12 adjacent the circumferential edge thereof, are also positioned between, and fused in the welding process to, facing surfaces of the first annular support 28 and second annular support 30. The resulting fused area or welding bead 32 forms a permanent and sealed fused connection, between and to, the first annular support 28 and second annular support 30, and a circumferential edge portion 36 encircling the filter element 12.

As such, the circumferential edge portion 36 around the entire circumference of the filter element 12 is fused during welding to both the first annular support 28 and second annular support 30. This fused engagement, formed by welding and visible at the welding bead 32, provides significant support preventing any deflection or movement of the perimeter edge of the filter element 12, when exposed to high fluid pressure. This is because the first annular support 28 is in a fused connection to the perimeter and one side surface of the filter element 12, and the second annular support 30 is in a fused connection to the other side of the filter element 12. The welding process also connects first annular support 28 in a fused connection to the second annular support 30 about the perimeter of both.

In a second action, with the filter element insert 26 so formed of the unitary structure of the first annular support 28, the metallic sintered filter element 12, and the second annular support 30, all in fused engagement, the filter insert 26 may be placed in a press-fit engagement. This press-fit engagement locates the circumferential perimeter surface 34 of the formed filter element insert 26, against the circumferential interior surface 24 of the mounting ring 14 which defines the fluid passage 20 therethrough. This press-fit forms a sealed engagement of the filter element insert 26 with and within the fluid passage 20 which will not dismount or deflect to cause blow-by under pressure. The circumferential perimeter surface 34 of the formed insert 26 may be equal to, or slightly larger than, the size of the circumferential interior surface 24. If slightly larger, for example, by one or a few microns, if the filter element insert 26 is cooled to at least 30 degrees Fahrenheit, it may be positioned within the interior surface 24 and when it returns to room temperature, will form a biased engagement therein.

It is envisioned that the method of forming the filter element insert 26 can be performed alone and the second action of press fitting the formed filter element insert 26 can be performed at a much later date. In this fashion, replacement filter element inserts 26 can be stored. They can later be press fit into a sealed engagement into a mounting ring 14 when needed. This also allows filter elements 12 of different sintered filters having different passage sizes therethrough to be stored and engaged when filtration to that passage size is needed.

While all of the fundamental characteristics and features of the disclosed sintered filter device and method of formation thereof have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A sintered filter for fluid filtering comprising:
a sintered filter formed of metal, said sintered filter having a perimeter edge surrounding an internal area of said sintered filter;
a first annular support formed of metal positioned on a first side of said sintered filter;
a second annular support formed of metal positioned on a second side of said sintered filter;
a fused connection formed of said metal of said sintered filter with said metal of said first annular support and said metal of said second annular support; and
said fused connection formed completely said perimeter edge of said sintered filter.

2. The sintered filter for fluid filtering of claim 1, additionally comprising:
said fused connection forming a filter element with said sintered filter positioned between first annular element and said second annular element;
said first annular support of said filter insert having a first exterior surface formed around a perimeter thereof said second annular support of said filter insert having a second exterior surface formed around a perimeter thereof; and
said filter insert having an insert exterior surface therearound defined by said first exterior surface in an alignment with said second exterior surface.

3. The sintered filter for fluid filtering of claim 1, additionally comprising:
said fused connection also connecting said first annular support to said second annular support with said perimeter edge of said sintered filter positioned within said fused connection therebetween;
said first annular support and said second annular support in said fused connection with said sintered filter therebetween, forming a filter insert;
said fused connection forming a filter element with said sintered filter positioned between first annular element and said second annular element;
said first annular support of said filter insert having a first exterior surface formed around a perimeter thereof said second annular support of said filter insert having a second exterior surface formed around a perimeter thereof; and
said filter insert having an insert exterior surface therearound defined by said first exterior surface in an alignment with said second exterior surface.

4. The sintered filter for fluid filtering of claim 2, additionally comprising:
a mounting ring, said mounting ring having a fluid passage communicating therethrough, said fluid passage defined by an interior surface of said mounting ring surrounding said fluid passage;
said insert exterior surface of said filter insert having a first diameter;
said fluid passage of said mounting ring having a second diameter;
said first diameter being equal to or slightly larger than said second diameter;
said filter insert being removably engaged within said fluid passage with said interior surface of said mounting ring in contact with said insert having an insert exterior surface of said filter insert; and
an exterior circumference of said mounting ring formed to engage in a sealed mount with a fluid conduit whereby pressurized fluid within said fluid conduit with said mounting ring in said sealed mount is communicated through said sintered filter.

5. The sintered filter for fluid filtering of claim 3, additionally comprising:
a mounting ring, said mounting ring having a fluid passage communicating therethrough, said fluid passage defined by an interior surface of said mounting ring surrounding said fluid passage;
said insert exterior surface of said filter insert having a first diameter;
said fluid passage of said mounting ring having a second diameter;
said first diameter being equal to or slightly larger than said second diameter;
said filter insert being removably engaged within said fluid passage with said interior surface of said mounting ring in contact with said insert having an insert exterior surface of said filter insert; and
an exterior circumference of said mounting ring formed to engage in a sealed mount with a fluid conduit whereby pressurized fluid within said fluid conduit with said mounting ring in said sealed mount is communicated through said sintered filter.

6. The sintered filter for fluid filtering of claim 2, additionally comprising:
a circumferential edge portion of said internal area of said sintered filter, said circumferential edge portion positioned adjacent to said perimeter edge of said sintered filter; and
said fused connection including all of said circumferential edge portion therein.

7. The sintered filter for fluid filtering of claim 3, additionally comprising:
a circumferential edge portion of said internal area of said sintered filter, said circumferential edge portion positioned adjacent to said perimeter edge of said sintered filter; and
said fused connection including all of said circumferential edge portion therein.

8. The sintered filter for fluid filtering of claim 4, additionally comprising:
a circumferential edge portion of said internal area of said sintered filter, said circumferential edge portion positioned adjacent to said perimeter edge of said sintered filter; and
said fused connection including all of said circumferential edge portion therein.

9. The sintered filter for fluid filtering of claim 5, additionally comprising:
a circumferential edge portion of said internal area of said sintered filter, said circumferential edge portion positioned adjacent to said perimeter edge of said sintered filter; and
said fused connection including all of said circumferential edge portion therein.
